(19) United States
(12) Patent Application Publication
(10) Pub. No.: US 2007/0172316 A1
(43) Pub. Date: Jul. 26, 2007

(54) HOBBING CUTTER

(75) Inventors: Thomas Jacob, Geesthacht (DE); Klaus-Dieter Schlisio, Buchen (DE)

Correspondence Address: VIDAS, ARRETT & STEINKRAUS, P.A., 6109 BLUE CIRCLE DRIVE, SUITE 2000, MINNETONKA, MN, 55343-9185, US

(73) Assignee: Fette GmbH, Schwarzenbek (DE)

(21) Appl. No.: 11/626,743

(22) Filed: Jan. 24, 2007

(30) Foreign Application Priority Data
Jan. 25, 2006 (DE) 20 2006 001 112.9

(51) Int. Cl. B26D 1/12

(52) U.S. Cl. 407/23

(57) ABSTRACT

A hobbing cutter with a hob body which circumferentially has at least one helically shaped flight or a plurality of annular flights, including flanks on either side of a flight apex, wherein the flanks have alternately mounted thereon indexable inserts by means of screws and the indexable inserts extend into the flight apex, wherein the cutting edges of adjoining hobbing flights further are at a twisted offset from a line which runs in parallel with the axis of the hob body, and wherein the indexable inserts have associated therewith radially outwardly open chutes which transversely extend through the flight apex, wherein the cutting edges of the indexable inserts of adjoining flights are disposed at such an offset from each other that a straight shank of a screwdriver can be passed through a close-to-apex portion of the chutes in order to be engaged with a mounting bolt of an indexable insert on the adjoining flight.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

From DE 27 00 525 A1, the entire contents of which is incorporated herein by reference, hobbing cutters have become known in which the indexable inserts made of cemented carbide are disposed on disc-shaped toothed rims in a helical distribution.

From DE 80 27 631 U1, the entire contents of which is incorporated herein by reference, hobbing cutters have become known in which a plurality of identical, helically extending toothed segments are disposed on a basic body in a thread-shaped guide of the basic body in a twisted offset of the cutting edges of indexable inserts of adjoining cutter body flights from the axially parallel centerline. The teeth carry indexable inserts in an alternate succession. Moreover, additional indexable inserts are provided at the bases of the teeth in an alternate succession.

As is known the indexable inserts are attached to the edges of the discs or toothed segments by means of bolts. Since a very large number of indexable inserts are mostly arranged on a hobbing cutter it is necessary to loosen and retighten many bolts if indexable inserts are to be exchanged. Since the annular or helically shaped flights of hobbing cutters often are located very close to each other, for example, a special wrench is needed to get at and actuate the bolt heads.

It is the object of the invention to provide a hobbing cutter with indexable inserts in which it is easier to mount and remove the indexable inserts and time for assembly and disassembly is reduced significantly.

### BRIEF SUMMARY OF THE INVENTION

In the inventive hobbing cutter, the cutting edges of the indexable inserts of adjoining flights are disposed at an offset from each other, preferably by about half a pitch.

The indexable inserts are arranged at a certain pitch in hobbing cutters of this type. If the pitch on a flight is chosen so as to offset the adjoining flight in the pitch by a half, for example, the indexable inserts of a flight will be located each in the gap of the indexable inserts of adjoining flight as seen in the axial direction of the hobbing cutter. The cutting edges of the indexable inserts have associated therewith chip flutes. If the flutes are open in a radially outward direction, i.e. if they define a recess at the apex of the flights, e.g. the toothed segments, it thus becomes possible to grip the bolt of the indexable insert on the adjoining flight through a flute by means of a simple rotating tool. Hence, the bolts of the indexable inserts of the inventive hobbing cutter can be accessed by a simple screw-driving tool and, in this way, can be loosened or tightened rapidly, e.g. also by means of motor-driven screwdriver. Thus, this simplifies the exchange of indexable inserts on a hobbing cutter and considerably reduces the time needed.

Another advantage of the inventive hobbing cutter lies in low vibration and a twisted arrangement of cutting edges. Cutting forces get neutralized because of the alternation of left-hand and right-hand cutting edges.

### BRIEF DESCRIPTION OF THE SEVERAL VIEWS OF THE DRAWINGS

An embodiment of the invention will be explained below with reference to the drawings.

FIG. 1 shows a developed portion of a hobbing cutter of the invention.

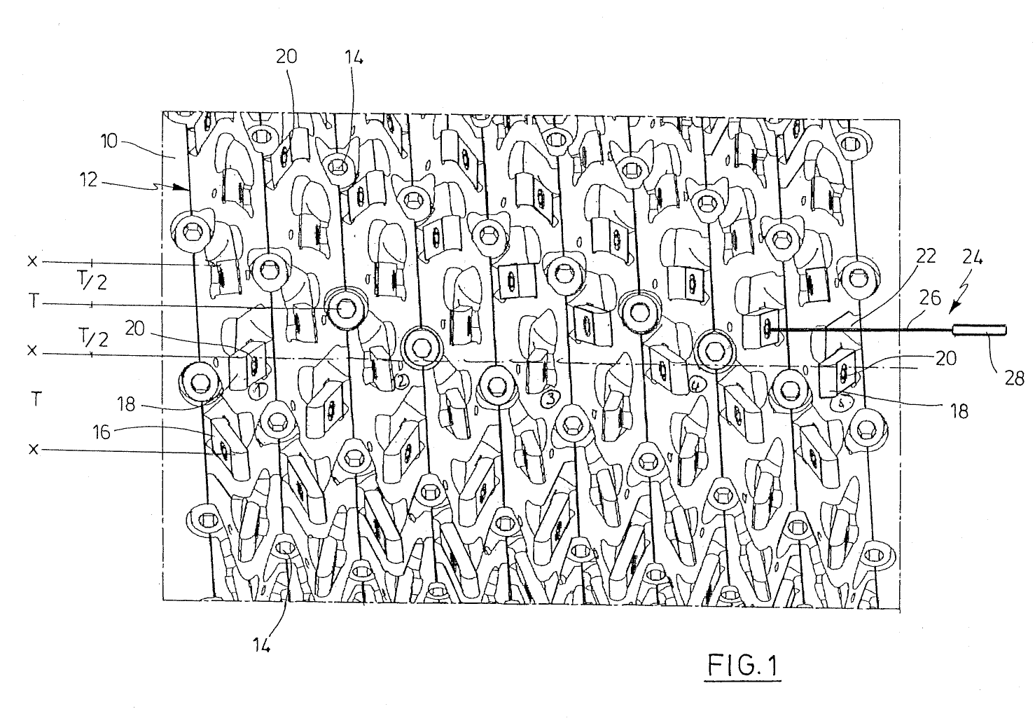

FIG. 2 shows a side view of a hobbing cutter of the invention and the use of a screwdriver.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated

A basic body, which is not shown, carries individual toothed segments 10 in a thread-like guide. Such a construction is disclosed in DE 80 27 631 U1, for example. The toothed segments 10 are of the same type and extend in a helical shape. This way defines adjacent toothed rims 12 or flights where the toothed segments are attached to the basic body, which is not shown, by means of bolts 14. The mounting arrangement is such that the bolts fix toothed segments of adjoining flights together. The toothed segments 10 have fixed thereon first indexable inserts 16 and second indexable inserts 18 by means of bolts 20. They are attached to the flanks of segments or flights with the bolts 20 extending so as to be approximately perpendicular to the flanks The indexable inserts 16 are located on one side (flank) of the toothed segments 10 (on the lift-hand side of the figure) while the indexable inserts 18 are located on the opposite side of the toothed segments 10. The indexable inserts 16, 18 are fixed to the toothed segments 10 at a predetermined pitch T. As can be seen from the Figures the indexable inserts 16, 18 are disposed at an offset of half a pitch T/2 on the adjoining flight.

The indexable inserts 16, 18 have associated therewith chip flutes 22. The chip flutes 22 extend through the apex of the toothed segments 10 and also are offset from adjoining flights and, therefore, it is possible to access the bolts 20 of the indexable inserts 16, 18 by using a simple screwdriver as is shown for a schematically outlined screwdriver 24 which has a straight shank 26 and a handle 28. Alternatively, a motor-driven screwdriver naturally can be used as well. The shank 26 is passed through the near-the-apex region of a flute 22 and its end may come into engagement with the mounting bolt 20 of the adjacent flight that faces it.

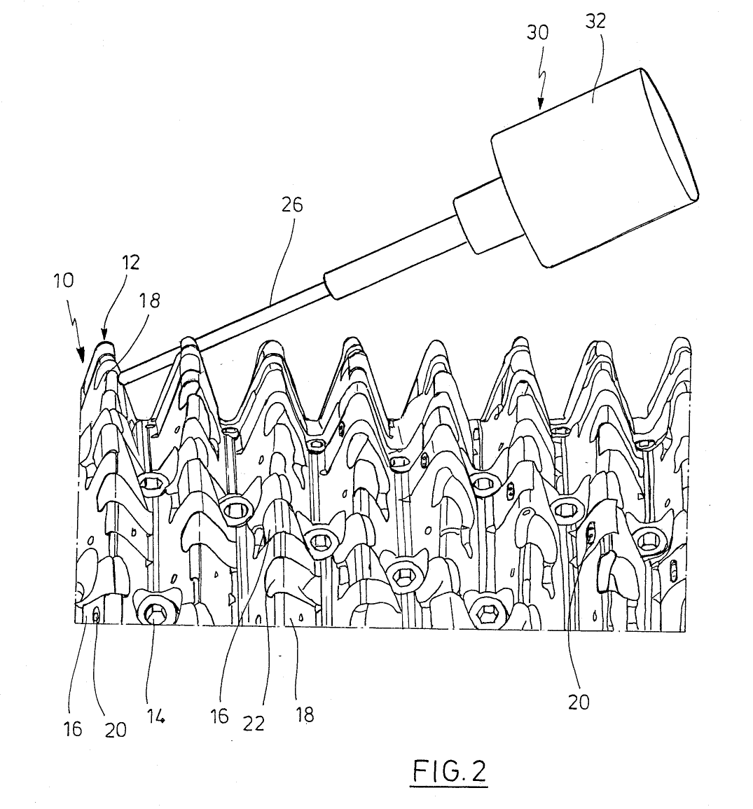

A motor-driven screwdriver 30 is outlined in FIG. 2 where the drive of the shank 26 is housed in a casing 32.

As can further appreciated from the figures, the cutting edges of the indexable inserts 16, 18 of the flights following the next ones are on a common plane each with the indexable inserts 16, 18 alternating with each other.

In all, this arrangement generates a low-vibration milling process because the cutting edge assembly is twisted, for the rest. The alternation of right-hand and left-hand cutting edges causes cutting forces to get neutralized.

Rather than using individual toothed segments, for example, toothed discs which are lined up in a juxtaposed way may be employed as carriers for the indexable inserts.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

What is claimed is:

1. A hobbing cutter with a hob body which circumferentially has at least one helically shaped flight or a plurality of annular flights, including flanks on either side of a flight apex, wherein the flanks have alternately mounted thereon indexable inserts by means of screws and the indexable inserts extend into the flight apex, wherein the cutting edges of adjoining hobbing flights further are at a twisted offset from a line which runs in parallel with the axis of the hob body, and wherein the indexable inserts have associated therewith radially outwardly open chutes which transversely extend through the flight apex, characterized in that the cutting edges of the indexable inserts (16, 18) of adjoining flights (12) are disposed at such an offset from each other that a straight shank (26) of a screwdriver (24, 30) can be passed through a close-to-apex portion of the chutes (22) in order to be engaged with a mounting bolt (20) of an indexable insert (16, 18) on the adjoining flight (12).

2. The hobbing cutter according to claim 1, characterized in that a basic body has provided thereon a plurality of identical toothed segments helically disposed in succession which are attached to the basic body by means of screws (14).

3. The hobbing cutter according to claim 1, characterized in that the hob body has juxtaposed discs with flanks and an apex.

4. The hobbing cutter according to claim 1, characterized in that the cutting edges of the indexable inserts (16, 18) of adjoining flights (12) are disposed at an offset of half a pitch T/2 from each other.
